(19) United States
(12) Patent Application Publication
(10) Pub. No.: US 2006/0185233 A1
(43) Pub. Date: Aug. 24, 2006

(54) Decorative structural supports

(76) Inventor: Joseph Sporta, Orangeville (CA)

Correspondence Address: MANELLI DENISON & SELTER, 2000 M STREET NW SUITE 700, WASHINGTON, DC, 20036-3307, US

(21) Appl. No.: 11/053,956

(22) Filed: Feb. 10, 2005

(51) Int. Cl. A01G 17/14

(52) U.S. Cl. 47/47

(57) ABSTRACT

A process for making a support member having a rigid elongate body formed of a member material comprising a plastics material and an outer surface comprising a plurality of non-longitudinal surface portions defining raised ridges outstanding from said member, said process comprising extruding said plastics material at a melt temperature through a die orifice at a selected extrusion rate and die orifice temperature to produce an extruded profile having an outer surface, the improvement comprising said extrusion rate and die orifice temperature being selected as to cause said outer surface to continuously, consistently and intermittently adhere to and be released from the die as defined by the stick-slip effect to form a desired plurality of scallop, wave-like ridges of uniform constant inter-ridge distance and essentially uniform height on said surface. The process provides a support member having a rigid elongate body formed of a member material comprising a plastics material and an outer surface comprising a plurality of non-longitudinal surface portions defining raised ridges outstanding from said member of use as a support structure, particularly, for plants, ornamental and other garden structures.

### FIELD OF THE INVENTION

This invention relates to support structures for plants, ornamental and other garden structures and the like formed of a plastics material, particularly a plastics composite material; and particularly decorative supports.

### BACKGROUND OF THE INVENTION

A rigid elongate structure, such as rods or sticks formed of wood, bamboo, metal and plastic materials for supporting plants or in the form of an archway, trellis and the like are known. However, such structures are generally conspicuous in being visibly distinct from the plants, such as vines, flowers, ivy and the like. To provide a support structure which blends with the plants and the like as to offer an attractive, natural-looking appearance background while providing a self-supporting structure would be a most commercially attractive product.

### SUMMARY OF THE INVENTION

It is an object of the present invention to provide a rigid elongate support for use with plants, vines, ivy and the like, or as a self-supporting structure.

Accordingly, in a broad aspect, the invention provides a support member having a rigid elongate body formed of a member material comprising a plastics material and an outer surface comprising a plurality of non-longitudinal surface portions defining raised ridges outstanding from said member.

The ridges may protrude at angles ranging from being perpendicular to about 10°, preferably 30° to the longitudinal axis of the body.

Preferably, the body surface comprises a plurality of short, discrete ridges of relatively uniform height of a constant or non-constant inter-ridge distance. The inter-ridge distances may be of any desired values per unit length of the body, preferably selected from 2 to 10 ridges per inch of length.

Preferably, the support member comprises a cylinder, optionally, hollow, wherein each of the ridges extends, in whole or in part, regularly or irregularly around the circumference of the surface.

The plurality of raised portions may extend the length of the support member or intermittently of the length of the support member.

The plastics material may be uniaxially oriented for additional strength.

In preferred embodiments, the member material may comprise the plastics material in admixture with a particulate material, such as for example, natural fiber materials such as rice hulls, peanut shells or minerals such as mica or silica rod, aluminum, brass, stainless steel, fiber glass, oriented polymers or any material that is not easily broken. Preferably, the particulate material is selected from the group consisting of wood flour, mica and a pigment, which pigment may provide the surface with the appearance of the colour of the pigment speckled with the colour of another particulate material.

The member may further comprise a reinforcing member embedded within the body, wherein the reinforcing member is preferably selected from a mesh, tube, bar and rod, optionally formed of a metal, extending the length of the body in whole or in part.

The tube, bar or rod may have an essentially pointed protrusion axially extending from said body at an end thereof to assist in entry into the soil, ground, sand, lawn and the like.

The tube, bar or rod may also have a head or stud, axially extending from the body at an end thereof distal to said pointed protrusion, upon which a hammer or the like may be struck to assist entry into the ground.

The preferred appearance of a ridge is that of a wave, optionally, having a crest.

The support preferably is to simulate the surfaces of and colours of a variety of woods, natural tree barks, and plant materials.

The elongate body having the ridged surfaces as defined in the present invention also advantageously provides the person handling it with an improved gripping, non-slip surface to assist in manually forcing the member into the ground with reduced risk of injury. Further, the ridges also advantageously provide for the attachment of string, wire or the like which remains in place rather than sliding down the member as is found often with prior art embodiments.

The ridge is formed by the known phenomenon of so-called “stick-slip”, stick-swell, or melt fracture. Well-known and unwanted in the art, stick-slip occurs when the molten polymer at the die wall alternates between moving and stationary, i.e. for one moment it adheres or “sticks” to the die wall and then, as stress in the polymer builds to overcome the adhesion, it releases itself from the wall and slips. The prior art, which invariably desires to prevent stick-slip, teaches that various steps can be taken to avoid stick-slip, which reduces the shear stress at the wall of the die. Processing aids can be added which allows the material to fully slip, while die temperature can be increased which promotes slip, while die gaps can be opened up to reduce the shear stress. Also, throughput rates can be decreased to reduce the stress below the critical range or increased beyond the range, to avoid stick-slip.

With high density polyethylene (HDPE) melt fracture usually occurs around the critical shear stress of about 0.14 megapascals. The addition of various amounts of fillers into virgin resin changes the flow characteristics of the material and the nature of the melt fracture. The normal process of operation is to extrude a profile and, if melt fracture occurs, to change some of the operating parameters, as described hereinabove to avoid it.

In the practise of the process of the invention, the desirable stiffness for a typical 1 m long rod may be readily selected and determined by experiment. The diameter of the extrusion die orifice and the die land-length, prior to but adjacent the orifice and die geometry, is similar to standard extrusion dies of use in the art. Typically, the selected land-length distance is about five times the orifice diameter. The new die diameter is preferably determined by selecting the rod stiffness desired and projecting from known, experimentally, previously produced sizes. For each die size and reinforcing rod diameter, selected in the same proportions as the known sample, which combination is determined experimentally, there is the point where the desired stick-slip is produced under the right operating conditions. For example, for a 9/16″ rod, setpoints, generally, are an extrusion rate of 12 feet per minute and a die temperature of 305° F. for a polymer composite of HDPE (49.5 wt %), wood flour (49.5 wt %) and (1 wt %) colour batch.

Additional property enhancing additives, such as, for example, ultra violet stabilizers and fungal resistant retardants, such as, for example, zinc borate may be added as a decay preservative.

Under preferred extrusion conditions, the polymer swells as it exits the die and in so doing the outer material of the extrudate adheres to the die face, i.e. the face perpendicular to the centerline of the die orifice, until enough material builds up as is then taken away by the inner material flowing freely from the die, i.e. not under the influence of the die face. This action produces the “breaking wave” like appearance on the cooling rod. The wave most often does not break away around the entire die circumference at the same time, but irregularly so as to produce a seemingly random period of waves around the rod circumference. The sizes of the waves vary somewhat along the rod length and around the circumference, although a statistical sample shows a predominant size of wave depending on the exact extrusion conditions. The spacing between waves is, typically, from ⅛ to ⅜″, while the exact pattern may be controlled by varying either the extrusion rate or die temperature. For different degrees of desired rod roughness, as, for example, selected by the desired visual appearance, the spacing and amplitude of the breaking waves can be varied somewhat by altering the die temperature or the extrusion rate.

Thus, in operation, the polymer blend or composite thereof, is fed to the die at a melt temperature for extrusion to form a rod, stick or other profile as is known in the art for the production of a continuous smooth-surfaced product. However, in the practice of the present invention, as hereinabove defined, the extrusion rate of the polymer melt and the die orifice temperature are selected as to cause the polymer surface to continuously, consistently and intermittently adhere to the die and subsequently be released, as described by the stick-slip effect, in forming individual ridges or scallops on the rod or profile surface.

Accordingly, in a further aspect, the invention provides a process for making a support member having a rigid elongate body formed of a member material comprising a plastics material and an outer surface comprising a plurality of non-longitudinal surface portions defining raised ridges outstanding from said member, said process comprising extruding said plastics material at a melt temperature through a die orifice at a selected extrusion rate and die orifice temperature to produce an extruded profile having an outer surface, the improvement comprising said extrusion rate and die orifice temperature being selected as to cause said outer surface to continuously, consistently and intermittently adhere to and be released from the die as defined by the stick-slip effect to form a desired plurality of scallop, wave-like ridges of uniform constant inter-ridge distance and essentially uniform height on said surface.

The aforesaid stick-slip effect on the profile surface may be controlled to occur at any rate of, typically, for example, 1 to 20 times per second, preferably, approximately 10 times per second, depending on the desired product appearance.

Examples of products made according to the invention as hereinabove defined, include, but are not limited to:—

horticultural products of all types such as, straight or spiral garden stakes, plant markers, garden obelisks, trellises, loop stakes, arches, support rings, planters, pots, baskets, brackets, hang up hooks, hose garden supports, artificial trees, branches and the like;

building products, such as, shingles, siding and the like; and

ornate furniture components and, complete items, profiles used in picture frames, decorative ornaments, and the like.

### BRIEF DESCRIPTION OF THE DRAWINGS

In order that the invention may be better understood, preferred embodiments will now be described by way of example, only, with reference to the drawings wherein

FIG. 1 is a diagrammatic, cross-sectional side view of an extrusion apparatus for producing product profiles according to the prior art; and

FIG. 2 is a diagrammatic side-view of a rod, in part according to the invention.

### DETAILED DESCRIPTION OF PREFERRED EMBODIMENTS

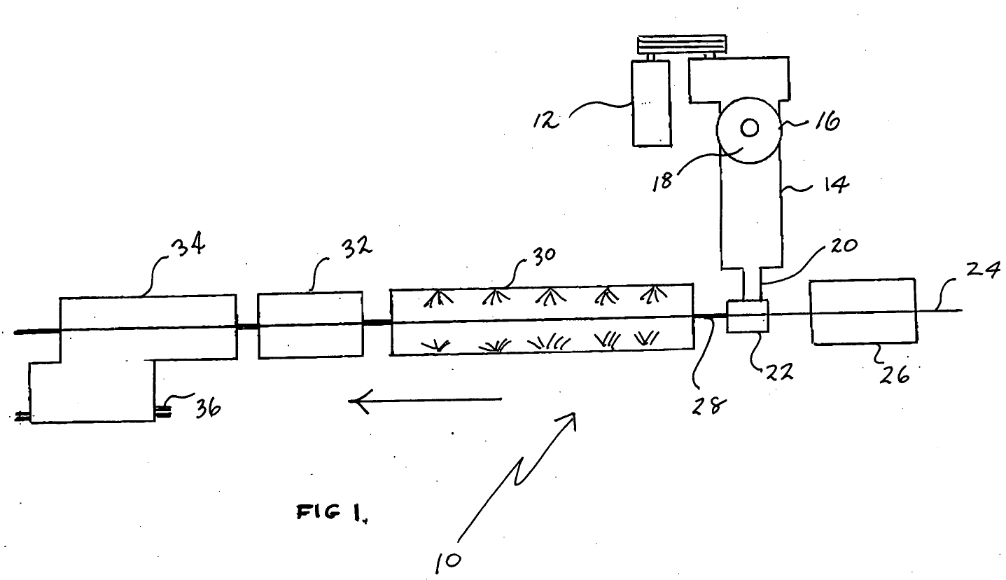

Reference is now made to FIG. 1 which shows, generally as 10, extrusion apparatus of use in the practice of the invention.

Apparatus 10 comprises

a variable speed extruder motor 12,

an extruder 14 with temperature control panel,

an extruder hopper 16 filled with plastic composite pellets 18,

a die adaptor 20,

a cross head die 22,

a steel reinforcing rod 24,

a variable speed rod pusher 26, to produce

a coated rod 28, according to the invention,

a spray cooling tank with appropriate heat exchanger 30,

variable speed puller 32 and a

cut-off saw and discharge table 34 to provide the profile 36 according to the invention.

The process according to the invention is carried out according to typical extrusion profile conditions and steps provided that the stick-slip effect is intentionally created on a continuously intermittent, consistent basis to provide the desired effect on the profile surface for the desired profile length and location.

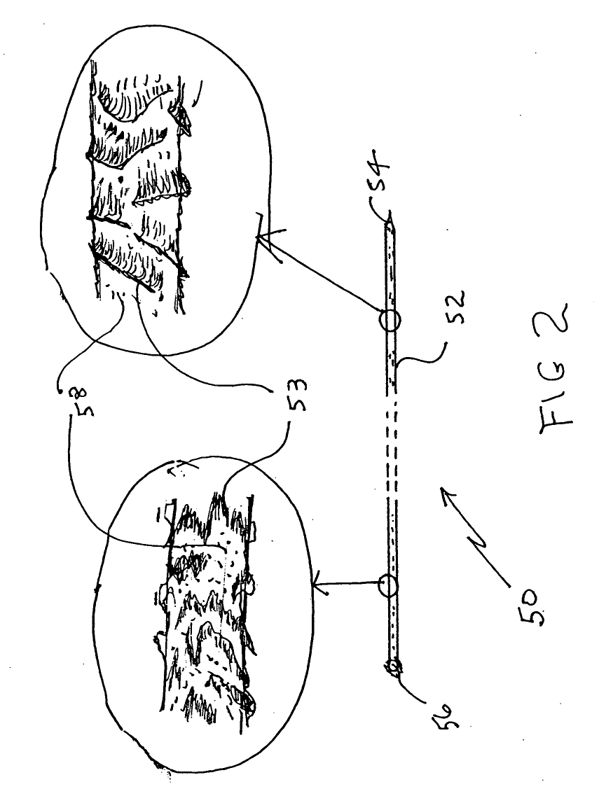

FIG. 2 shows generally as 50, a side view of a garden plant support rod-member 52 of about 1 m in length and 1.25 cm outside diameter formed of a mica-containing HDPE composite material having a plurality of discrete wave-like, scallop-like ridges 54.

Rod 52 has an inner reinforcing steel rod of about 0.7 cm outside diameter having a pointed ground entering tip 54 at one end of the rod and a blow-receiving head 56 at the other end thereof, distal to end 54.

Micro particles 58 at the surface of rod 52 are seen as speckled discrete entities within a green coloured, plant stem-like background caused by a suitable pigment in admixture in the composite.

The ridges run essentially off-set from the perpendicular to the longitudinal axis of the rod in this embodiment, at an inter-ridge spacing of about 1 cm. The ridges are not of the same exact height, width or length, but essentially have a constant inter-wave distance.

The dark green or brown-grey coloured rod 52 simulates the colour shade of a natural plant or bark, stem of a plant, bush or tree bark.

The presence of the mica or alternative selected particulate material in the composite can provide an attractive speckled discrete appearance and, thus, a favourable visual effect to the profile to enhance its utility.

A typical product according to the invention may be prepared, briefly, as follows with extrusion apparatus operative in the prior art.

Inner reinforcing rod: 0.25″ outside diameter steel.

Material composition: preferred; composite 49.5% HDPE, 49.5% wood flour, 1% colour masterbatch.

Other preferred materials; Polymer: either virgin or recycled HDPE, LDPE, PP.

Filler: natural fiber materials, such as rice hulls, peanut shells or minerals such as mica or silica rod, aluminum, brass, stainless steel, fiber glass, oriented polymers or any material that is not easily broken.

Process Conditions: preferred embodiment is a single screw extruder producing a composite melt temperature of about 310° C., through an orifice of 0.62″ dia. at a temp. of 306 F. with a rod speed of 13 ft/min.

The extruder can be a single screw of the appropriate size for the desired output or a twin screw machine. In the case of the latter the plastic material and filler would be kept separate until inside the extruder. The twin screw machine is preferred for large volume production since it lowers the material cost.

The through put rate and temperature will vary for a given orifice size depending on the material composition and rod size used and the desired pattern.

In operation, composite material is fed into an extruder which melts and pumps the material through a cross head die where the material exits at 90 deg. from where it entered, rotated in a horizontal plane. The rod is fed into the die at 90 deg to the extruder, coaxially with the exit orifice of the die after it has passed through a pusher and prior to that a straightener and uncoiling device if supplied in coil form or a rod feeder if individual straight pieces are used. The rod speed and extruder output rate can both be controlled separately. After the product exits the die through the orifice it passes into a water spray chamber and is cooled. Upon exiting the water chamber it passes through an air dryer blower which dries the rod, a pulling device which draws the rod and a cutoff saw.

The extruded composite can be of a single polymer/filler matrix or it can be co-extruded from two or more materials having different properties to create special effects such as two colors, two strengths of material with stronger material in the core of virgin material and the outer layer of filled material

Alternatively if the product is to be formed into various shapes by bending it would exit into a winding/forming fixture and once the pattern or shape is complete the whole structure would be cooled.

The exit orifice of the die can be any shape and can be designed to create a fractured pattern on all or only selected surfaces by surface finish, surface coating or localized temperature differences.

The hot material can be woven or formed into longitudinal shapes, sticks to itself or other materials. When cold, the material can be cut, nailed, screwed into, shaven, glued, grooved/slit or clamped.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. A support member having a rigid elongate body formed of a member material comprising a plastics material and a pigment in admixture with said plastics material and having an outer surface comprising a plurality of non-longitudinal surface portions defining raised ridges outstanding from said member.

2. A member as defined in claim 1 wherein said support member comprises a cylinder wherein each of said ridges extends in whole or in part irregularly around the circumference of said surface.

3. A member as defined in claim 1 wherein said plurality of raised portions extend the length of said support member.

4. A member as defined in claim 1 wherein said plurality of raised portions extend intermittently of the length of said support member.

5. A member as defined in claim 2 wherein said cylinder is hollow.

6. A member as defined in claim 1 wherein said plastics material is uniaxially oriented.

7. A member as defined in claim 1 wherein said member further comprises a particulate material, in admixture with said pigment and said plastics material.

8. A member as defined in claim 7 wherein said particulate material is selected from the group consisting of natural fiber materials such as wood flour, ground wood pulp, recycled paper, rice hulls, peanut shells, minerals mica, silica rod, aluminum, brass, stainless steel, fiber glass, oriented polymers or any material that is not easily broken.

9. (canceled)

10. A member as defined in claim 1 wherein said surface has an appearance of the colour of said pigment speckled with the colour of said particulate material.

11. A member as defined in claim 1 further comprising a reinforcing member embedded within said body.

12. A member as defined in claim 11 wherein said reinforcing member is selected from a mesh, tube, bar and rod extending the length of said body in whole or in part.

13. A member as defined in claim 12 wherein said tube, bar or rod is formed of a metal.

14. A member as defined in claim 13 wherein said tube, bar or rod has an essentially pointed protrusion axially extending from said body at an end thereof.

15. A member as defined in claim 13 wherein said tube, bar or rod has a head axially extending from said body at an end thereof.

16. (canceled)
